(19) United States
(12) Patent Application Publication
(10) Pub. No.: US 2019/0102065 A1
(43) Pub. Date: Apr. 4, 2019

(54) INTERACTION PERSONALIZATION SYSTEM AND METHOD

(71) Applicant: Gamalon, Inc., Cambridge, MA (US)

(72) Inventors: BENJAMIN W. VIGODA, Winchester, MA (US); Joel Bauman, San Jose, CA (US); Glynnis Kearney, Medford, MA (US)

(21) Appl. No.: 16/151,003

(22) Filed: Oct. 3, 2018

Related U.S. Application Data
(60) Provisional application No. 62/567,973, filed on Oct. 4, 2017.

(51) Int. Cl. G06F 3/0481; G06F 3/0482; G06F 3/01; G06F 3/16

(52) U.S. Cl. CPC G06F 3/04817; G06F 3/167; G06F 3/017; G06F 3/0482

(57) ABSTRACT

A computer-implemented method, computer program product and computing system for rendering an initial item; receiving a selection command concerning the initial item from a user; selecting a preferred response item, chosen from a plurality of response items defined for the initial item, wherein the preferred response item is associated with a path that is based, at least in part, upon one or more user criteria associated with the user; and rendering the preferred response item.

### RELATED APPLICATION(S)

This application claims the benefit of the following U.S. Provisional Application No. 62/567,973, filed on 4 Oct. 2017, their entire contents of which are herein incorporated by reference.

### TECHNICAL FIELD

This disclosure relates to interaction systems and, more particularly, to interaction systems that personalize the user experience.

### BACKGROUND

Personalization has become a necessary component of successful consumer-facing digital marketing efforts, wherein existing solutions may personalize using segmentation and content. Segmentation may often be based on broad variables such as demographics and past purchase history.

Using various tools, marketers may create broad segments by coding manual rules. Content personalization may be typically accomplished by sending e.g., different emails, different blog posts, or other kinds of differing content to different segments. Content personalization may also be done by ranking pieces of content differently depending upon segment, wherein different segments may see different pieces of content.

### SUMMARY OF DISCLOSURE

Auto Selection System

In one implementation, a computer-implemented method is executed on a computing device and includes: rendering an initial item; receiving a selection command concerning the initial item from a user; selecting a preferred response item, chosen from a plurality of response items defined for the initial item, wherein the preferred response item is associated with a path that is based, at least in part, upon one or more user criteria associated with the user; and rendering the preferred response item.

One or more of the following features may be included. A query from the user may be received. The query may be executed. A result set may be rendered that includes the initial item. The initial item may include one or more of: a uniform resource locator; and an object. The one or more user criteria associated with the user may include one or more of: a user-defined preference; and a previous user experience. Rendering the preferred response item may include one or more of: navigating to a defined location; and rendering an object. The plurality of response items may include one or more of: one or more response items that are proactively-defined for the initial item prior to receiving the selection command; and one or more response items that are reactively-defined for the initial item after receiving the selection command. Receiving a selection command may include one or more of: receiving a device-based selection command; receiving a voice-based selection command; and receiving an action-based selection command.

In another implementation, a computer program product resides on a computer readable medium and has a plurality of instructions stored on it. When executed by a processor, the instructions cause the processor to perform operations including rendering an initial item; receiving a selection command concerning the initial item from a user; selecting a preferred response item, chosen from a plurality of response items defined for the initial item, wherein the preferred response item is associated with a path that is based, at least in part, upon one or more user criteria associated with the user; and rendering the preferred response item.

One or more of the following features may be included. A query from the user may be received. The query may be executed. A result set may be rendered that includes the initial item. The initial item may include one or more of: a uniform resource locator; and an object. The one or more user criteria associated with the user may include one or more of: a user-defined preference; and a previous user experience. Rendering the preferred response item may include one or more of: navigating to a defined location; and rendering an object. The plurality of response items may include one or more of: one or more response items that are proactively-defined for the initial item prior to receiving the selection command; and one or more response items that are reactively-defined for the initial item after receiving the selection command. Receiving a selection command may include one or more of: receiving a device-based selection command; receiving a voice-based selection command; and receiving an action-based selection command.

In another implementation, a computing system including a processor and memory is configured to perform operations including rendering an initial item; receiving a selection command concerning the initial item from a user; selecting a preferred response item, chosen from a plurality of response items defined for the initial item, wherein the preferred response item is associated with a path that is based, at least in part, upon one or more user criteria associated with the user; and rendering the preferred response item.

One or more of the following features may be included. A query from the user may be received. The query may be executed. A result set may be rendered that includes the initial item. The initial item may include one or more of: a uniform resource locator; and an object. The one or more user criteria associated with the user may include one or more of: a user-defined preference; and a previous user experience. Rendering the preferred response item may include one or more of: navigating to a defined location; and rendering an object. The plurality of response items may include one or more of: one or more response items that are proactively-defined for the initial item prior to receiving the selection command; and one or more response items that are reactively-defined for the initial item after receiving the selection command. Receiving a selection command may include one or more of: receiving a device-based selection command; receiving a voice-based selection command; and receiving an action-based selection command.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes an input & selection process according to an embodiment of the present disclosure;

FIG. 2 is a flowchart of an implementation of the input & selection process of FIG. 1 according to an embodiment of the present disclosure;

FIG. 3 is a diagrammatic view of content rendered by the input & selection process of FIG. 1 according to an embodiment of the present disclosure;

FIG. 4 is another diagrammatic view of content rendered by the input & selection process of FIG. 1 according to an embodiment of the present disclosure; and

FIG. 5 is another diagrammatic view of content rendered by the input & selection process of FIG. 1 according to an embodiment of the present disclosure.

Like reference symbols in the various drawings indicate like elements.

### DETAILED DESCRIPTION OF THE PREFERRED EMBODIMENTS

System Overview

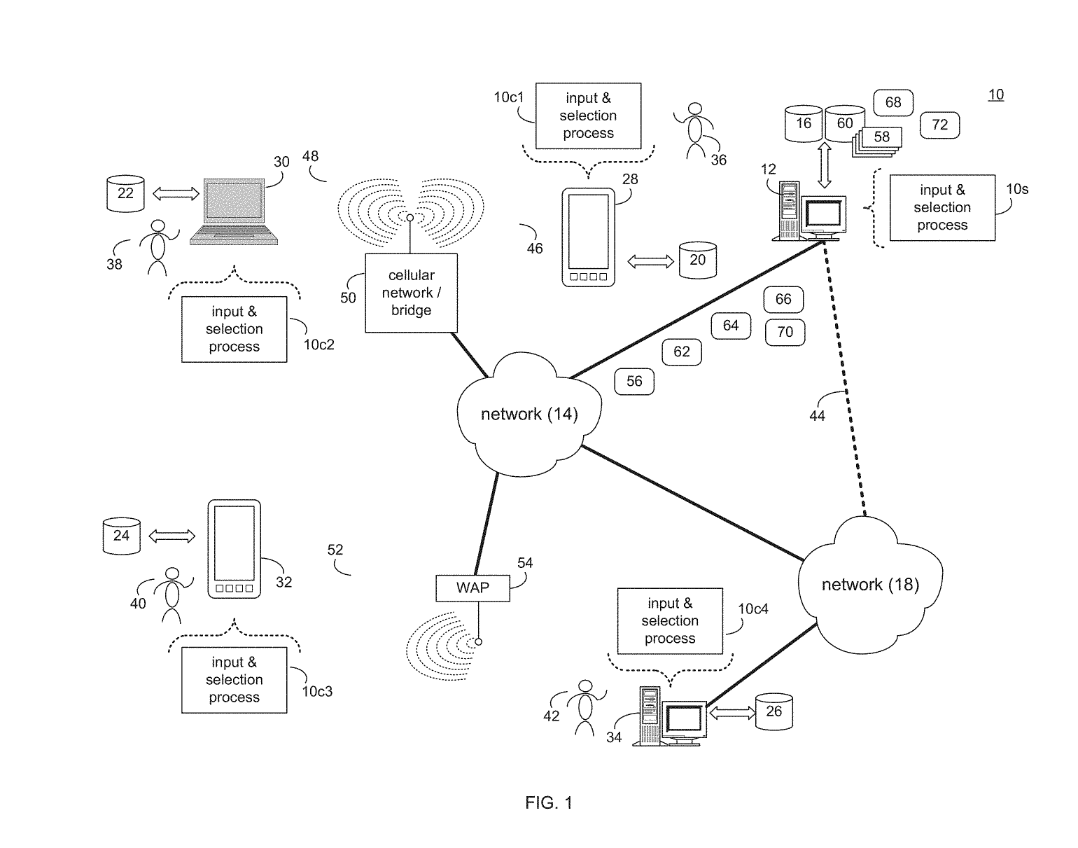

Referring to FIG. 1, there is shown input & selection process 10. Input & selection process 10 may be implemented as a server-side process, a client-side process, or a hybrid server-side/client-side process. For example, input & selection process 10 may be implemented as a purely server-side process via input & selection process 10s. Alternatively, input & selection process 10 may be implemented as a purely client-side process via one or more of input & selection process 10c1, input & selection process 10c2, input & selection process 10c3, and input & selection process 10c4. Alternatively still, input & selection process 10 may be implemented as a hybrid server-side/client-side process via input & selection process 10s in combination with one or more of input & selection process 10c1, input & selection process 10c2, input & selection process 10c3, and input & selection process 10c4. Accordingly, input & selection process 10 as used in this disclosure may include any combination of input & selection process 10s, input & selection process 10c1, input & selection process 10c2, input & selection process, and input & selection process 10c4.

Input & selection process 10s may be a server application and may reside on and may be executed by computing device 12, which may be connected to network 14 (e.g., the Internet or a local area network). Examples of computing device 12 may include, but are not limited to: a personal computer, a laptop computer, a personal digital assistant, a data-enabled cellular telephone, a notebook computer, a television with one or more processors embedded therein or coupled thereto, a cable/satellite receiver with one or more processors embedded therein or coupled thereto, a server computer, a series of server computers, a mini computer, a mainframe computer, or a cloud-based computing network.

The instruction sets and subroutines of input & selection process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of input & selection processes 10c1, 10c2, 10c3, 10c4 may include but are not limited to a web browser, a game console user interface, or a specialized application (e.g., an application running on e.g., the Android™ platform or the iOS™ platform). The instruction sets and subroutines of input & selection processes 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage device 16 may include but are not limited to: a hard disk drive; a RAID device; a random access memory (RAM); a read-only memory (ROM); and all forms of flash memory storage devices.

Examples of client electronic devices 28, 30, 32, 34 may include, but are not limited to, data-enabled, cellular telephone 28, laptop computer 30, personal digital assistant 32, personal computer 34, a notebook computer (not shown), a server computer (not shown), a gaming console (not shown), a smart television (not shown), and a dedicated network device (not shown). Client electronic devices 28, 30, 32, 34 may each execute an operating system, examples of which may include but are not limited to Microsoft Windows™, Android™, WebOS™, iOS™, Redhat Linux™, or a custom operating system.

Users 36, 38, 40, 42 may access input & selection process 10 directly through network 14 or through secondary network 18. Further, input & selection process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, data-enabled, cellular telephone 28 and laptop computer 30 are shown wirelessly coupled to network 14 via wireless communication channels 46, 48 (respectively) established between data-enabled, cellular telephone 28, laptop computer 30 (respectively) and cellular network/bridge 50, which is shown directly coupled to network 14. Further, personal digital assistant 32 is shown wirelessly coupled to network 14 via wireless communication channel 52 established between personal digital assistant 32 and wireless access point (i.e., WAP) 54, which is shown directly coupled to network 14. Additionally, personal computer 34 is shown directly coupled to network 18 via a hardwired network connection.

WAP 54 may be, for example, an IEEE 802.11a, 802.11b, 802.11g, 802.11n, Wi-Fi, and/or Bluetooth device that is capable of establishing wireless communication channel 52 between personal digital assistant 32 and WAP 54. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### Input & Selection Process:

Assume for illustrative purposes that input & selection process 10 may be configured to enhance the level of personalization experienced by a user when browsing and searching websites/content. In this illustrative example, assume that user 38 is searching the internet so that they may rent a vacation home. Further assume that user 38 visits a rental website (e.g., www.ABCVacationRentals.com) that enables users to rent vacation homes. Additionally, assume that user 38 enters the appropriate search criteria (e.g., Timeframe: July 3^{rd}-July 10^{th}; Location: Key West, Fla.; and Price Range: $4,000-$5,000) required by www.ABCVacationRentals.com to effectuate such a search.

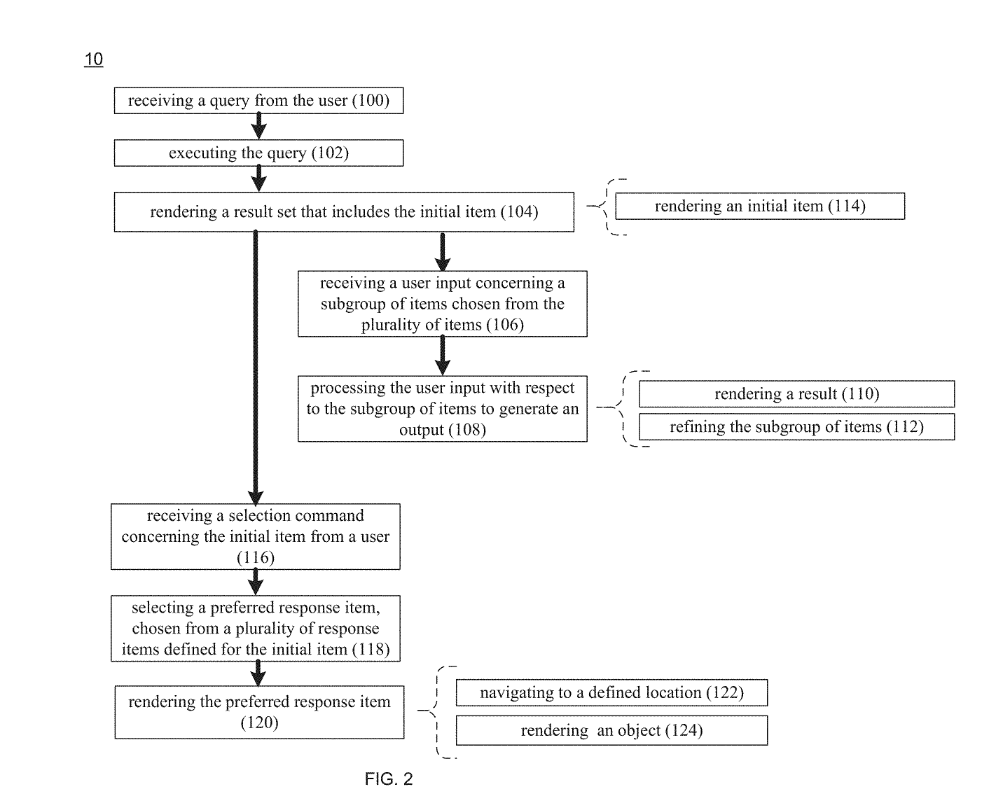

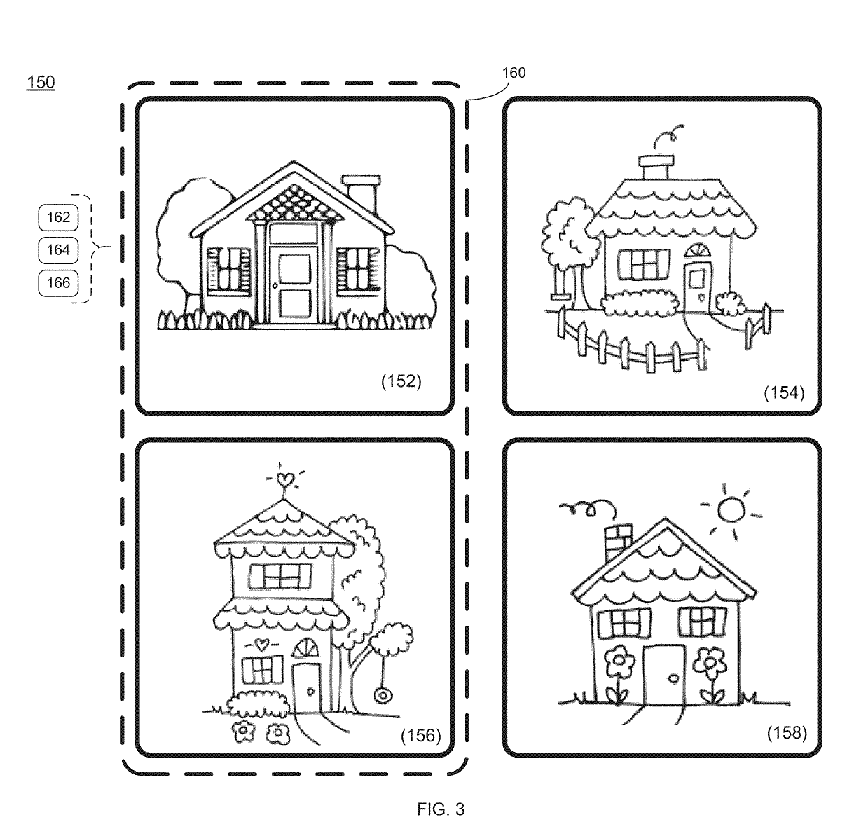

Accordingly and referring also to FIGS. 2-3, input & selection process 10 may receive 100 query 56 (e.g., Timeframe: July 3^{rd}-July 10^{th}; Location: Key West, Fla.; and Price Range: $4,000-$5,000) from user 38. wherein input & selection process 10 may execute 102 query 56 and may render 104 result set 150 that includes a plurality of items. When executing 102 query 56, input & selection process 10 may compare available vacation properties 58 defined within property database 60 to the terms defined within query 56.

While in this example, result set 150 is shown to include four items (e.g., namely items 152, 154, 156, 158), this is for illustrative purposes only and is not intended to be a limitation of this disclosure, as other configurations are possible and are considered to be within the scope of this disclosure. For example, the quantity of items included within result set 150 may be increased or decreased for various reasons (e.g., design criteria, the quantity of available vacation properties 58 defined within database 60, the quantity of available vacation properties 58 that meet the requirements of query 56, and/or the scope of the terms defined within query 56).

One or more of items 152, 154, 156, 158 may be a uniform resource locator. As in known in the art, a uniform resource locator (URL), colloquially termed a web address, may be a reference to a web resource that specifies its location on a computer network and a mechanism for retrieving it. A URL may be a specific type of uniform resource identifier (URI), although many people use the two terms interchangeably. URLs occur most commonly to reference web pages (http), but are also used for file transfer (ftp), email (mailto), database access (JDBC), and many other applications. Most web browsers display the URL of a web page above the page in an address bar. A typical URL may have the form http://www.example.com/index.html, which may indicate a protocol (http), a hostname (www.example.com), and a file name (index.html). Accordingly, one or more of items 152, 154, 156, 158 may be a uniform resource locator that points to a webpage (not shown) that provides information concerning (in this example) one or more of the vacation homes associated with items 152, 154, 156, 158.

Additionally/alternatively, one or more of items 152, 154, 156, 158 may be an object, examples of which may include but are not limited to an image, a picture, a word, a portion of text, a sound recording, and a video clip. For example, if the user (e.g., user 38) was simply searching for images of vacation homes, one or more of items 152, 154, 156, 158 may be an object (e.g., a photograph) of a vacation home that is not linked to any webpage.

Input & selection process 10 may receive 106 a user input (e.g., user input 62) concerning a subgroup of items (e.g., subgroup of items 160) chosen from result set 150. This subgroup of items (e.g., subgroup of items 160) chosen from result set 150 may include or more of: a single item chosen from result set 150 and multiple items chosen from result set 150. For example, subgroup of items 160 may include one of items 152, 154, 156, 158 from result set 150, a plurality of items 152, 154, 156, 158 from result set 150, or all of items 152, 154, 156, 158 from result set 150.

User input 62 may take many forms, examples of which may include but are not limited to: a device-based user input; a voice-based user input; and an action-based user input.

Device-Based User Input:

User 38 may utilize a device (e.g., a pointing device, a keyboard, etc.) associated with client electronic device 30 to generate user input 62. For example, user 38 may utilize the keyboard of client electronic device 30 to generate a text-based user query and/or a text-based comment that is provided to input & selection process 10. Further, user 38 may utilize the pointing device of client electronic device 30 to make a selection of one or more of items 152, 154, 156, 158 that is provided to input & selection process 10 to form subgroup of items 160.

Voice-Based User Input:

Client electronic device 30 may be coupled to (or include) a microphone and, therefore, client electronic device 30 may be capable of receiving and processing voice-based user input. For example and utilizing speech-to-text technology available from various parties, user 38 may verbalize a user query and/or comment that is processed to form a text-based query/comment and provided to input & selection process 10. Further, user 38 may verbalize a selection of one or more of items 152, 154, 156, 158 that is processed and provided to input & selection process 10 to form subgroup of items 160.

Action-Based User Input:

Client electronic device 30 may be a touch sensitive device and, therefore, client electronic device 30 may be capable of receiving action-based user input. For example, user 38 may “write” a user query and/or comment (onto a touch-sensitive screen) that may be processed to form a text-based query/comment and provided to input & selection process 10. Further, user 38 may utilize such a touch-sensitive screen to make a selection of one or more of items 152, 154, 156, 158 (via tapping, circling, etc.) that is processed and provided to input & selection process 10 to form subgroup of items 160.

As discussed above, the user input (e.g., user input 62) received 106 from user 38 by input & selection process 10 may concern a subgroup of items (e.g., subgroup of items 160) chosen from result set 150. Input & selection process 10 may be configured so that the user (e.g., user 38) is provided with a high level of freedom and flexibility concerning the manner in which user input 62 is defined. For the following example, assume that subgroup of items 160 include two items (namely item 152 and item 156). wherein user 38 is potentially interested in renting one of these two vacation homes.

Specifically, input & selection process 10 may be configured so that the sequence in which user input 62 and subgroup of items 150 are defined does not matter. Therefore and when receiving 106 user input 62 concerning subgroup of items 160, input & selection process 10 may first receive user input 62 and may then define subgroup of items 160. Alternatively and when receiving 106 user input 62 concerning subgroup of items 160, input & selection process 10 may first define subgroup of items 160 and may then receive user input 62.

Continuing with the above-stated example in which user 38 is considering renting one of the two vacation properties defined by items 152, 156 within subgroup of items 160, assume that client electronic device 30 is configured to receive and process voice-based user input and action based user input. Accordingly, user 38 may first say “Do these houses have pools?” (thus defining a user query) and may then tap the touch-sensitive screen included within client electronic device 30 to select items 152, 156 (thus defining subgroup of items 160); thus resulting in the generation of user input 62. Alternatively, user 38 may first tap the touch-sensitive screen included within client electronic device 30 to select items 152, 156 (thus defining subgroup of items 160) and may then say “Do these houses have pools?” (thus defining a user query); thus resulting in the generation of user input 62.

Once user input 62 is received 106, input & selection process 10 may process 108 user input 62 with respect to subgroup of items 160 to generate output 64. When processing 108 user input 62 with respect to the subgroup of items 160 to generate output 64, input & selection process 10 may render 110 a result and/or refine 112 subgroup of items 160.

Continuing with the above-stated example in which user 38 says “Do these houses have pools?” (thus defining a user query) and taps the touch-sensitive screen included within client electronic device 30 to select items 152, 156 (thus defining subgroup of items 160) to generate user input 62, input & selection process 10 may process 108 user input 62. Specifically, input & selection process 10 may utilize speech-to-text technology to convert the speech-based question of “Do these houses have pools?” into a text-based inquiry that is processed 108 by input & selection process 10. Once converted into text, input & selection process 10 may utilize machine learning and/or artificial intelligence to process 108 the text-based inquiry of “Do these houses have pools?” with respect to subgroup of items 160.

When processing 108 user input 62, input & selection process 10 may use probabilistic modeling to accomplish such processing 108, wherein examples of such probabilistic modeling may include but are not limited to discriminative modeling (e.g., a probabilistic model for only the content of interest), generative modeling (e.g., a full probabilistic model of all content), or combinations thereof. As is known in the art, probabilistic modeling may be used within modern artificial intelligence systems (e.g., input & selection process 10), in that these probabilistic models may provide artificial intelligence systems with the tools required to autonomously analyze data.

Examples of the tasks for which probabilistic modeling may be utilized may include but are not limited to:
predicting media (music, movies, books) that a user may like or enjoy based upon media that the user has liked or enjoyed in the past;
transcribing words spoken by a user into editable text;
grouping genes into gene clusters;
identifying recurring patterns within vast data sets;
filtering email that is believed to be spam from a user's inbox;
generating clean (i.e., non-noisy) data from a noisy data set; and
diagnosing various medical conditions and diseases.

For each of the above-described applications of probabilistic modeling, an initial probabilistic model may be defined, wherein this initial probabilistic model may be iteratively modified and revised based upon feedback provided by users, thus allowing the probabilistic models and the artificial intelligence systems (e.g., input & selection process 10) to “learn” so that future probabilistic models may be more precise and may define more accurate data sets. Accordingly, input & selection process 10 may use various machine learning processes and algorithms to process 108 user input 62.

Continuing with the above-stated example in which user 38 says “Do these houses have pools?” and selects items 152, 156 (thus defining subgroup of items 160) to generate user input 62 so that input & selection process 10 may process 108 user input 62, assume that the vacation property associated with item 152 (within subgroup of items 160) does indeed have a pool, while the vacation property associated with item 156 (within subgroup of items 160) does not.

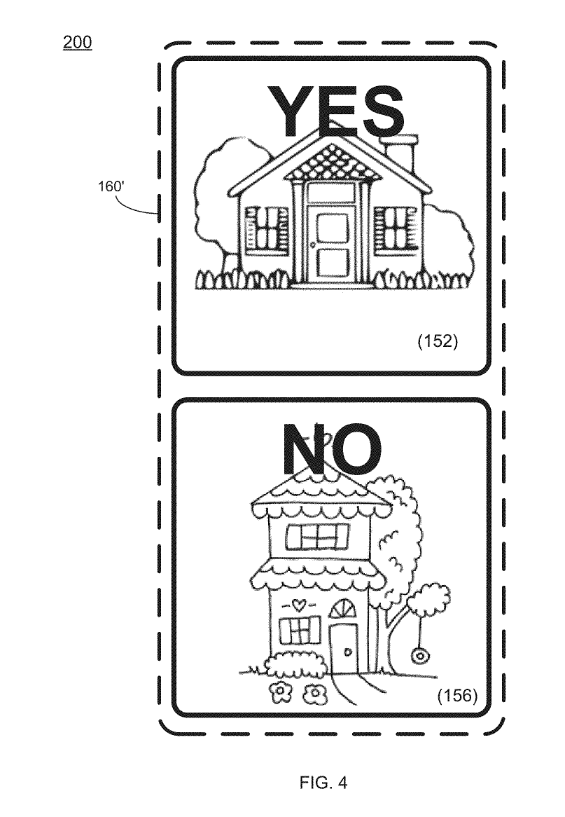

Accordingly and referring also to FIG. 4, input & selection process 10 may render 110 a result (e.g., result 200) and/or may refine 112 subgroup of items 160 (to form subgroup of items 160′). The manner in which result 200 may be rendered 110 and/or the manner in which subgroup of items 160 may be refined 112 (to form subgroup of items 160′) may occur in various ways and FIG. 4 is intended to show one possibility of such rendering 110 and/or refinement 112 by input & selection process 10. However, it is understood that this is merely for illustrative purposes only and is not intended to be a limitation of this disclosure, as other configurations are possible and are considered to be within the scope of this disclosure. However and as shown in FIG. 4, one such example of the rendering 110 of result 200 may include items 152, 156 be overlaid with an answer to the question (e.g., “Do these houses have pools?”) asked by user 38. Accordingly and as shown in FIG. 4, item 152 may be rendered 110 with an overlay that says “YES’ (as this vacation home does indeed include a pool); while item 156 may be rendered 110 with an overlay that says “NO’ (as this vacation home does not include a pool). Alternatively and concerning other ways in which result 200 may be rendered 110 and/or the manner in which subgroup of items 160 may be refined 112 (to form subgroup of items 160′), item 156 (i.e., the vacation home without a pool) may be removed or greyed out, thus resulting in only item 152 being included within subgroup of items 160′ after subgroup of items 160 is refined 112 by input and selection process 10).

Referring again to FIG. 3 and result set 150 that includes items 152, 154, 156, 158, assume for this example that result set 150 includes an item that user 38 is initially interested in (e.g., initial item 152). According and when rendering 104 result set 150, initial item 152 may also be rendered 114 by input & selection process 10. Accordingly, assume that user 38 selects initial item 152, thus resulting in the generation of selection command 66. Input & selection process 10 may receive 116 selection command 66 concerning initial item 152 from user 38.

When receiving 116 selection command 66, input & selection process 10 may receive 116 a device-based selection command; a voice-based selection command; and/or an action-based selection command. As discussed above, users (e.g., user 38) of input & selection process 10 may provide input (e.g., selection command 66) in various ways, examples of which may include but are not limited to: a device-based user input; a voice-based user input; and an action-based user input.
Device-Based User Input: Users may utilize a device (e.g., a pointing device, a keyboard, etc.) associated with client electronic device 30 to generate selection command 66.
Voice-Based User Input: Client electronic device 30 may be coupled to (or include) a microphone and, therefore, client electronic device 30 may be capable of receiving and processing voice-based selection command 66.
Action-Based User Input: Client electronic device 30 may be a touch sensitive device and, therefore, client electronic device 30 may be capable of receiving action-based selection command 66.

In response to receiving 116 selection command 66, input & selection process 10 may select 118 a preferred response item (e.g., preferred response item 162), chosen from a plurality of response items (e.g., response items 162, 164, 166) defined for initial item 152, wherein preferred response 162 is associated with a path that is based, at least in part, upon one or more user criteria (e.g., user criteria 68) associated with (in this example) user 38.

The plurality of response items (e.g., response items 162, 164, 166) defined for initial item 152 may include one or more of: one or more response items that are proactively-defined for initial item 152 prior to receiving selection command 66; and one or more response items that are reactively-defined for initial item 152 after receiving the selection command 66.

Concerning proactively-defined response items, examples of such response items may include but are not limited to response items that are proactively-defined by the people that are implementing (i.e., coding) the website associated with input & selection process 10. For example, the proactively-defined response items (e.g., response items 162, 164, 166) defined for initial item 152 may be hardcoded paths to the specific portions of the webpage/content that provides detailed information concerning the vacation home associated with initial item 152. These specific portions of the webpage/content may concern e.g., the location of the vacation home, the price range of the vacation home, the # of bedrooms of the vacation home, the # of floors of the vacation home, the hot tub of the vacation homes, the pool of the vacation home, and the garage of the vacation home. Accordingly and upon receiving 116 selection command 66, input & selection process 10 may process user criteria 68 and may select 118 (via e.g., machine learning/artificial intelligence) preferred response item 162 from the proactively-defined plurality of response items (e.g., response items 162, 164, 166) based upon such user criteria 68. For example, input & selection process 10 may process user criteria 68 and may select 118 preferred response item 162 that includes a path to the specific portions of the webpage/content associated with initial item 152 that concern e.g., the pool of the vacation home.

Concerning reactively-reactively defined response items, examples of such response items may include but are not limited to response items that are reactively-defined by machine learning/artificial intelligence after receiving selection command 66. Accordingly and upon receiving 116 selection command 66, input & selection process 10 may process user criteria 68 to determine the interests of user 38. Further, input & selection process 10 may process the webpage/content associated with initial item 152 to identify specific portions of that webpage/content that may be interesting to users 38 (based upon user criteria 68). Accordingly, input & selection process 10 may select 118 (via e.g., machine learning/artificial intelligence) preferred response item 162 from the reactively-defined plurality of response items (e.g., response items 162, 164, 166) based upon such user criteria 68. For example, input & selection process 10 may process user criteria 68 and may select 118 preferred response item 162 that includes a path to the specific portions of the webpage/content associated with initial item 152 that concern e.g., the pool of the vacation home.

The one or more user criteria (e.g., user criteria 68) associated with (in this example) user 38 may include one or more of: a user-defined preference; and a previous user experience.

Accordingly and with respect to user-defined preferences, input & selection process 10 may allow user 38 to define one or more preferences within user criteria 68 that is maintained by input & selection process 10 for user 38. For example, input & selection process 10 may be configured to allow user 38 to define their interests with respect to e.g., vacation home location, vacation home price range, vacation home # of bedrooms, vacation home # of floors, the presences of hot tubs, the presence of pools, the presence of garages, etc. Accordingly and when selecting 118 a preferred response item (e.g., preferred response item 162), chosen from a plurality of response items (e.g., response items 162, 164, 166) defined for initial item 152, input & selection process 10 may select 118 a preferred response item (e.g., preferred response item 162) that most closely adheres to the one or more user criteria (e.g., user criteria 68) that were manually defined by and associated with user 38.

Accordingly and with respect to previous user experiences, assuming that user 38 has been previously searching for vacation homes with pools, input & selection process 10 may be aware that user 38 is often interested in pools. This information may be automatically stored within user criteria 68 that is maintained by input & selection process 10 for user 38. For example, input & selection process 10 may be configured to monitor and define the interests of user 38 with respect to e.g., vacation home location, vacation home price range, vacation home # of bedrooms, vacation home # of floors, the presences of hot tubs, the presence of pools, the presence of garages, etc. Accordingly and when selecting 118 a preferred response item (e.g., preferred response item 162), chosen from a plurality of response items (e.g., response items 162, 164, 166) defined for initial item 152, input & selection process 10 may select 118 a preferred response item (e.g., preferred response item 162) that most closely adheres to the one or more user criteria (e.g., user criteria 68) that were automatically defined for and associated with user 38.

In response to input & selection process 10 receiving 116 selection command 66 and selecting 118 preferred response item 162, input & selection process 10 may render 120 preferred response item 162. When rendering 120 preferred response item 162, input & selection process 10 may navigate 122 to a defined location within a webpage/content and/or may render 124 an object.

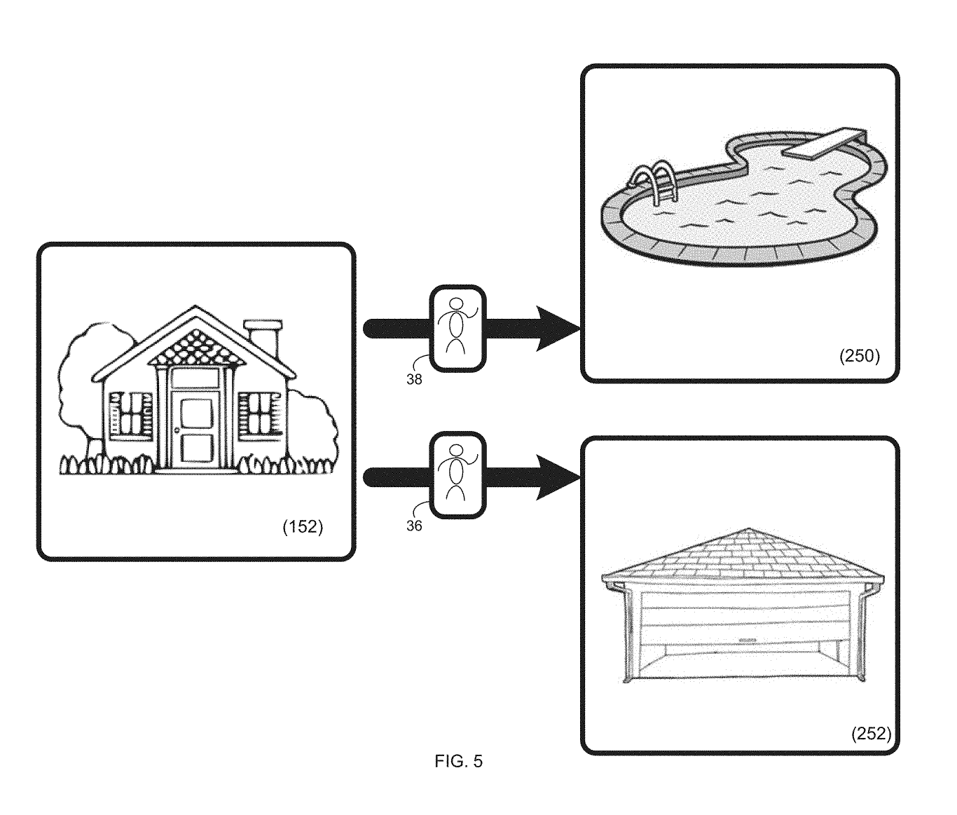

Referring also to FIG. 5 and continuing with the example in which user 36 is interested in vacation homes that include a pool, upon receiving 116 selection command 66, input & selection process 10 may select 118 preferred response item 162 that may navigate 122 to defined location 250 within a webpage/content for the vacation home associated with initial item 152 (and may render 124 related objects), wherein defined location 250 may concern the pool of the vacation home associated with initial item 152 (as input & selection process 10 utilized user criteria 68 of user 38 when selecting preferred response item 12).

Since the preferred response item selected 118 by input & selection process 10 is based upon such personal user criteria, in the event that a different user selects the same initial item, the preferred response item selected 118 by input & selection process 10 may be different. For example, assume that another user (e.g., user 36) is also searching for a vacation home in the same location and price range. However, user 36 does not care about whether the vacation home has a pool (as she cannot swim) but is very interested in whether the vacation home has a garage (as she drives an exotic car (e.g., a Ferrari) that she does not want to park on the street). Accordingly and when input & selection process 10 receives 116 selection command 70 from user 36, input & selection process 10 may select 118 a different preferred response item. For example, since user 36 is interested in vacation homes that include a garage, upon receiving 116 selection command 70, input & selection process 10 may select 118 preferred response item 164 that may navigate 122 to a defined location 252 within a webpage/content for the vacation home associated with initial item 152 (and may render 124 related objects), wherein defined location 252 may concern the garage of the vacation home associated with initial item 152 (as input & selection process 10 utilized user criteria 72 of user 36 when selecting preferred response item 12).

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
rendering an initial item;
receiving a selection command concerning the initial item from a user;
selecting a preferred response item, chosen from a plurality of response items defined for the initial item, wherein the preferred response item is associated with a path that is based, at least in part, upon one or more user criteria associated with the user; and
rendering the preferred response item.

2. The computer-implemented method of claim 1 further comprising:
receiving a query from the user;
executing the query, and
rendering a result set that includes the initial item.

3. The computer-implemented method of claim 1 wherein the initial item includes one or more of:
a uniform resource locator; and
an object.

4. The computer-implemented method of claim 1 wherein the one or more user criteria associated with the user includes one or more of:
a user-defined preference; and
a previous user experience.

5. The computer-implemented method of claim 1 wherein rendering the preferred response item includes one or more of:
navigating to a defined location; and
rendering an object.

6. The computer-implemented method of claim 1 wherein the plurality of response items includes one or more of:
one or more response items that are proactively-defined for the initial item prior to receiving the selection command; and
one or more response items that are reactively-defined for the initial item after receiving the selection command.

7. The computer-implemented method of claim 1 wherein receiving a selection command includes one or more of:
receiving a device-based selection command;
receiving a voice-based selection command; and
receiving an action-based selection command.

8. A computer program product residing on a computer readable medium having a plurality of instructions stored thereon which, when executed by a processor, cause the processor to perform operations comprising:
rendering an initial item;
receiving a selection command concerning the initial item from a user;
selecting a preferred response item, chosen from a plurality of response items defined for the initial item, wherein the preferred response item is associated with a path that is based, at least in part, upon one or more user criteria associated with the user; and
rendering the preferred response item.

9. The computer program product of claim 8 further comprising:
receiving a query from the user;
executing the query, and
rendering a result set that includes the initial item.

10. The computer program product of claim 8 wherein the initial item includes one or more of:
a uniform resource locator; and
an object.

11. The computer program product of claim 8 wherein the one or more user criteria associated with the user includes one or more of:
a user-defined preference; and
a previous user experience.

12. The computer program product of claim 8 wherein rendering the preferred response item includes one or more of:
navigating to a defined location; and
rendering an object.

13. The computer program product of claim 8 wherein the plurality of response items includes one or more of:
one or more response items that are proactively-defined for the initial item prior to receiving the selection command; and
one or more response items that are reactively-defined for the initial item after receiving the selection command.

14. The computer program product of claim 8 wherein receiving a selection command includes one or more of:
receiving a device-based selection command;
receiving a voice-based selection command; and
receiving an action-based selection command.

15. A computing system including a processor and memory configured to perform operations comprising:
rendering an initial item;
receiving a selection command concerning the initial item from a user;
selecting a preferred response item, chosen from a plurality of response items defined for the initial item, wherein the preferred response item is associated with a path that is based, at least in part, upon one or more user criteria associated with the user; and
rendering the preferred response item.

16. The computing system of claim 15 further comprising:
receiving a query from the user;
executing the query, and
rendering a result set that includes the initial item.

17. The computing system of claim 15 wherein the initial item includes one or more of:
a uniform resource locator; and
an object.

18. The computing system of claim 15 wherein the one or more user criteria associated with the user includes one or more of:
a user-defined preference; and
a previous user experience.

19. The computing system of claim 15 wherein rendering the preferred response item includes one or more of:
navigating to a defined location; and
rendering an object.

20. The computing system of claim 15 wherein the plurality of response items includes one or more of:
one or more response items that are proactively-defined for the initial item prior to receiving the selection command; and
one or more response items that are reactively-defined for the initial item after receiving the selection command.

21. The computing system of claim 15 wherein receiving a selection command includes one or more of:
receiving a device-based selection command;
receiving a voice-based selection command; and
receiving an action-based selection command.
